(19) United States
(12) Patent Application Publication
(10) Pub. No.: US 2004/0049444 A1
(43) Pub. Date: Mar. 11, 2004

(54) Trade supporting method and system

(76) Inventor: Kazuki Sato, Tokyo (JP)

Correspondence Address: Mitchell P. Brook, Esq., Luce Forward Hamilton & Scripps LLP, Suite 200, 11988 El Camino Real, San Diego, CA, 92130, US

(21) Appl. No.: 10/238,801

(22) Filed: Sep. 9, 2002

(51) Int. Cl. G06F 17/60

(52) U.S. Cl. 705/37

(57) ABSTRACT

To assist a business trade between a user who wants to sell an item and the other who wants to purchase an item by accepting an offer for the purchase through a home page disclosing information regarding to used goods. For the above procedure, the users are previously categorized into a plurality of groups to which different priorities are given respectively. The item information is presented to the users with expanding a scope of the access allowances in accordance with the priority and lapsed time since the information of the for-sale item is entered. In other words, the information is presented to the users by the order of the priorities from the highest to the lowest.

### FIELD OF THE INVENTION

The present invention relates to a system for assisting business trades of used goods with using a network.

### DESCRIPTION OF THE RELATED ART

Conventional process of transferring or selling used semiconductor manufacturing apparatus (semiconductor manufacturing equipment) has required the following steps.

A project manager prepares documents (release plan) based on the property management report, and send them to semiconductor manufacturing facilities (production lines). In each of the facilities, a person in charge reviews the equipment in the facility, and reports to the project manager whether the facility has appropriate apparatuses being applicable to the intrafirm transfer.

Another document which listing up the apparatuses being inapplicable to the intrafirm transfer may be prepared as a release item list. The list may be transferred to a broker who handling used semiconductor manufacturing apparatuses. The brokers may prepare their own documents as a for-sale item list for their business.

Accordingly, such the troublesome document preparation tasks are required at every stages through the project for intrafirm transfer of the used semiconductor manufacturing apparatuses. And, it is difficult for the brokers to find appropriate used goods which satisfy the buyers demands because their human resources are not limitless.

As the growth of IT (Information Technology), various goods have been traded via the Internet. As well as those general goods, the used semiconductor manufacturing apparatuses may be applicable to such the trading. However, specialty of the semiconductor manufacturing apparatuses requires a system to have extra functions rather than ordinary internet auction services, because information obtained via the internet may be insufficient for making decision on purchasing the semiconductor manufacturing apparatus.

Such the problem occurs in several fields handling secondhand goods, special purpose goods, highly-priced goods, and the like, because it is difficult to understand actuality or substance of those items based only on information obtained via the internet (even if it provides rich contents).

### SUMMARY OF THE NVENTION

The present invention has been made in consideration of the above problem, and it is an object of the present invention to simplify a business trade.

It is another object of the present invention to release both buyers and sellers from troublesome tasks in a business trade.

To achieve the above objects, a method for assisting a business trade according to a first aspect of the present invention is a method for assisting a business trade between a user who wants to sell an item and the other who wants to purchase an item by accepting an offer for the purchase through a home page disclosing information regarding to items, comprises:

categorizing the users into a plurality of groups to which different priorities are given; and

presenting the information regarding to the items to the users with gradually expanding a scope of the users in accordance with the priorities of the groups in order of the highest priority group to the lowest priority group.

In this case, for example, the method may accept the item entry; obtain time passage since the entry; and specify a group to which information regarding to the item is presented, based on the obtained time passage.

The method may enter information regarding to properties of a business body for a computer for management; and accept designation of a for-sale item which is one of the properties being managed, and uploading information regarding to the designated for-sale item to a home page, thus simplifying the property management and sales to the outside.

Not only the business trade between business bodies, the method may allow a business body (company, organization, or the like) to arrange intrafirm transfer, and presenting information regarding to the intrafirm transfer items only to the users in the business body concerned. In this case, the method may include: entering information regarding to properties of the business body to a computer for management; and accepting designation of an item to be subject to intrafirm transfer which is one of the properties being managed, and uploading information regarding to the designated item to be subject to the intrafirm transfer to a home page, thus allowing the business body to share the information regarding to the items being subject to the intrafirm transfer.

To achieve the above objects, a system for assisting a business trade according to a second aspect of the present invention is a system for assisting a business trade between a user who wants to sell an item and the other who wants to purchase an item by accepting an offer for the purchase from the applicant for the purchase through a home page disclosing information regarding to for-sale items, comprises:

a user information storing means for categorizing users into n (a natural number equal to or greater than 2) groups to each of which priority for information disclosure is assigned, and for storing information regarding to each of the users;

an item information storing means for accepting information regarding to for-sale items, and for storing the accepted information; and

an information presentation means for specifying the group to which a user belongs based on the information stored in the user information storing means in response to the access by the user via the network, retrieving information viewable by the specified group from the information regarding to the for-sale items stored in the item information storing means, and presents the retrieved information to the user via the network.

For example, the item information storing means may store entry date of the for-sale items, and

the information presentation means may obtain passage of time since the entry date for each for-sale item, and presents information to the users belonging to the group in accordance with the obtained passage of time.

For example, the information presentation means may present the information regarding to the for-sale items only to the users who belongs to the highest priority group during a predetermined term since the entry date until conclusion of the business trade, and gradually presents the information also to other users who belongs to the groups whose priority is the second best or lower after the predetermined term is lapsed in accordance with the time passage.

The users may be equipped with a computer which comprises a means for entering and managing information regarding to properties owned by the users concerned, and a computer which accepts designation of a for-sale item which is one of the properties being managed, and notifies the business trade assisting system of the information regarding to the designated property to be entered as the for-sale item information.

The for-sale items may be used goods. In this case, the item information storing means may comprise transfer information storing means for accepting an entry of information regarding to intrafirm transfer before the entry of the for-sale items,

the information presentation means may comprise a means for presenting the information regarding to the items being subject to the intrafirm transfer only to the business body which had signed-in and the users belonging to the business body concerned, and

the item information storing means may comprise a means for switching the information regarding to the items being subject to the intrafirm transfer into information of items to be sold to other business body.

The users may be equipped with a computer which comprises a means for entering and managing information regarding to the properties owned by the user concerned, and a means for accepting designation of an item being subject to the intrafirm transfer which is one of the properties being managed, and notifying the business trade assisting system of the information regarding to the designated property as an item to be subject to the intrafirm transfer, and the computer may be connected to the business trade assisting system via telecommunications.

The group having the highest priority may include, for example, the users who supply for-sale items, and

the item information storing means may comprise a means for accepting the entry of the for-sale items from the users in the highest priority group.

To achieve the above objects, a recording medium according to a third aspect of the present invention is a computer readable recording medium storing a program which causes a computer to act as a server for assisting a business trade between one who wants to sell an item and the other who wants to purchase an item, wherein accepting an offer from an applicant for the purchase through a home page disclosing information regarding to for-sale items, comprises:

a user information storing means for categorizing users into n (a natural number equal to or greater than 2) groups to each of which priority for information disclosure is assigned, and for storing information regarding to each of the users;

an item information storing means for accepting information regarding to for-sale items, and for storing the accepted information; and

an information presentation means for specifying the group to which a user belongs based on the information stored in the user information storing means in response to the access by the user via the network, retrieving information viewable by the specified group from the information regarding to the for-sale items stored in the item information storing means, and presents the retrieved information to the user via the network.

To achieve the above objects, a recording medium according to a fourth aspect of the present invention is a computer readable recording medium storing a program which causes a computer:

to be connected to a server which assists a business trade between one who wants to sell an item and the other who wants to purchase an item by accepting an offer from an applicant for the purchase through a home page disclosing information regarding to for-sale used items; and

to comprise a management means for entering and managing information regarding to the properties owned by the users, and a means for accepting designation of a for-sale item which is one of the properties from a user, and notifying the server of the information regarding to the designated property to enter as a for-sale used item.

### BRIEF DESCRIPTION OF THE DRAWINGS

FIG. 1 is a diagram showing the structure of the system for assisting a business trade of used goods according to an embodiment of the present invention.

FIG. 2 is a diagram showing the structure of the system for a business trade of used goods according to an example of the present invention.

FIG. 3 is a diagram exemplifying the structure of the site shown in FIGS. 1 and 2.

FIG. 4 is a diagram exemplifying the contents of the user information DB located in the site.

FIG. 5 is a diagram exemplifying the contents of the item information DB located in the site.

FIG. 6 is a diagram exemplifying the contents of the intrafirm transfer information DB located in the site.

FIG. 7 is a diagram exemplifying the structure of the user terminal.

FIG. 8 is a diagram exemplifying the property information table located in the user terminal.

FIG. 9 is a diagram showing an example of a login page.

FIG. 10 is a diagram showing an example of a sign-up page.

FIG. 11A and FIG. 11B are diagrams showing examples of menu pages for selecting intrafirm transfer information or for-sale information before viewing.

FIG. 12 is a diagram showing an example of an e-mail.

FIG. 13 is a diagram showing an example of a search query setting page.

FIG. 14 is a diagram showing an example of a search result page for Group A.

FIG. 15 is a diagram showing an example of a search result page for Group B.

FIG. 16 is a diagram showing an example of a search result page for Group C.

FIG. 17 is a diagram showing an example of a wanted item entry page.

FIG. 18 is a diagram showing an example of a for-sale item entry page.

### DETAILED DESCRIPTION OF THE PREFERRED EMBODIMENT

A system for assisting business trades of used semiconductor manufacturing apparatuses (semiconductor manufacturing equipment) according to an embodiment of the present invention, will now be described with reference to the accompanying drawings.

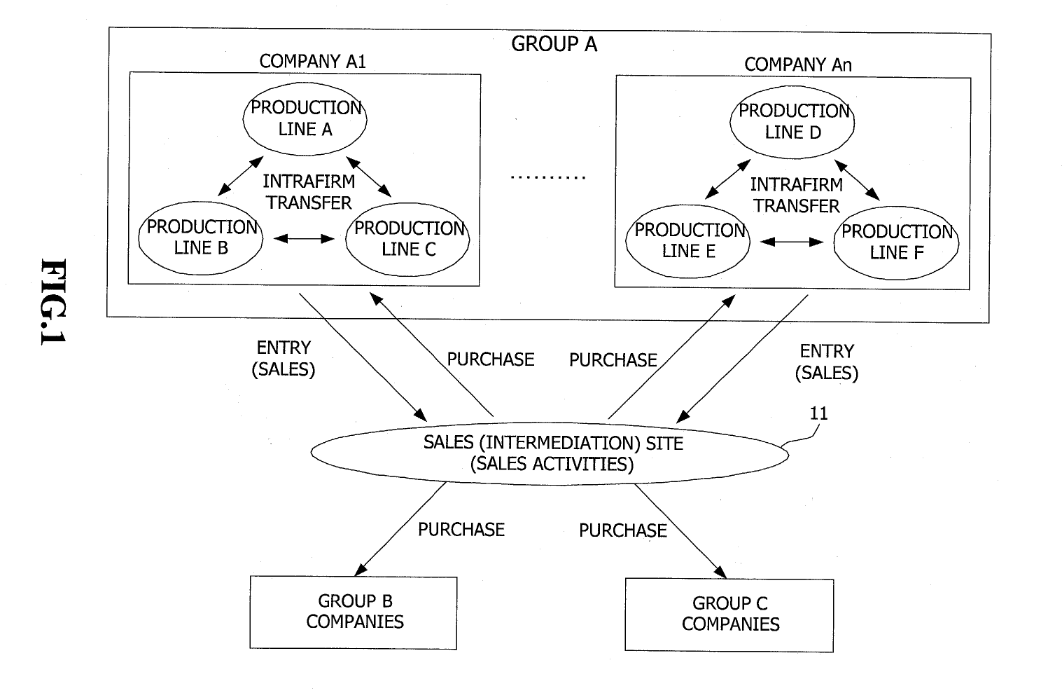

As shown in FIG. 1, the system according to this embodiment comprises a site 11 which contains information regarding to for-sale semiconductor manufacturing apparatuses.

The site 11 authorizes predetermined business bodies which had completed “sign-up ” for accessing the site 11. Therefore, the site 11 is accessible only by terminals belonging to the authorized business bodies, via a network such as the internet. The site 11 accepts entry (upload) of information regarding to the for-sale semiconductor manufacturing apparatus (for-sale data), and allows applicants for buying to view the entered for-sale data. That is, the site 11 intermediates a business trade between the parties concerned. The site 11 provides functions of searching, browsing, and entering the for-sale data, however, a function for completing the business trades (that is, “accounting” function) is omitted, because the information viewable via the internet is too insufficient to understand actuality or substances of the items (even if it provides rich contents), and inspection of actual condition is a necessary matter before purchasing.

Business bodies which are allowed to access the site 11 (that is, sign-up had been completed), are categorized into “Group A”, “Group B”, and “Group C”, in accordance with their businesses.

“Group A” includes main users of the cyber market provided by the site 11. Those users may be business bodies such as enterprises, laboratories, and universities, those are potential suppliers of used semiconductor manufacturing apparatuses. Each of the business bodies in Group A obtains special software for interaction with the site 11. The software allows the business body to upload information representing used semiconductor manufacturing apparatus to the site 11 as “for-sale item”. The software has another function to manage intrafirm transfer of equipment (including transfer between associated companies). The site 11 prepares private web site areas assigned to each of the group A members respectively for managing the intrafirm transfer. Each of the business bodies may upload a home page (HP) regarding to the intrafirm transfer to the private web site. Accesses to those private HP are controlled to maintain the private use.

In response to the “for-sale item” entry, the site 11 automatically prepares e-mail including information of the latest business trade, and distributes it to the group A members. The site 11 also allows the group A members to view the latest business trade information during a predetermined period, with the access control for eliminating accesses by the other business bodies in Group B and Group C.

Since the Group A is the category for the main users of the cyber market of the site 11, a newcomer may be required to pay a membership fee. The membership fee may be appropriated for the costs of, for example, software installation, configurations for each business body, preparation of the private HP, and the like.

On the other hand, Group A consists of users those intend to buy apparatuses mainly. The site 11 controls the accesses so that the group A members and the group B members are allowed to view the apparatus data after the period wherein the group A members are allowed to view the information prior to the others. The access control still eliminates group C members from viewing the information.

The group B members are also allowed to sell the apparatuses. In this case, they may have several ways for entry such as using a for-sale item entry form viewable on the home page provided by the site 11, and sending a document including necessary data for entry to the administrator of the site 11.

Any business bodies are allowed to access the site 11 after “sign up” through the home page of the site 11. Those users are categorized into Group C. Those group C members are also allowed to sell used apparatuses. In this case, the procedures the same as those for the group B members are required.

If an appropriate apparatus is found, the user notifies the site 11 that the user wishes to buy it. The service provider begins action for achievement. If an appropriate apparatus is not found, the user may enter wanted apparatus for the site 11.

A unique ID is issued to each the business body, and the business body may sets its own password. The business body thus signed-up may access the site 11, and fills in predetermined columns on the home page with ID and password. And, they are allowed to view the home page on the site 11. As for the group A members and the group B members, ID and password may be obtained beforehand through the sales activity of the site 11.

The site 11 specifies the group to which the business body concerned belongs, based on ID and password, and distinguishes information viewable by the user concerned based on the group.

The site 11 has a search page including combo box which lists articles to be selected by the signed-up user for easy search. Articles may be, for example, category, model, maker, and the like. Fine search is available with using search query (including single word or multiple words).

The apparatus list being viewable on the HP has an indicator “Offered” which indicates the status of business trades. The list also has indicators “Very New” and “New” each representing “entered in last 2 weeks” and “entered in last 4 weeks” respectively.

According to the above structure, business trades of used goods are arranged through the home page on the internet, thus, the efficiency of the business trades may be improved. And the users are categorized into groups those are prioritized for the access control. Such the priority may be incentive to participate in the cyber market for potential suppliers, thus, the market will be well supplied and active.

### EXAMPLES

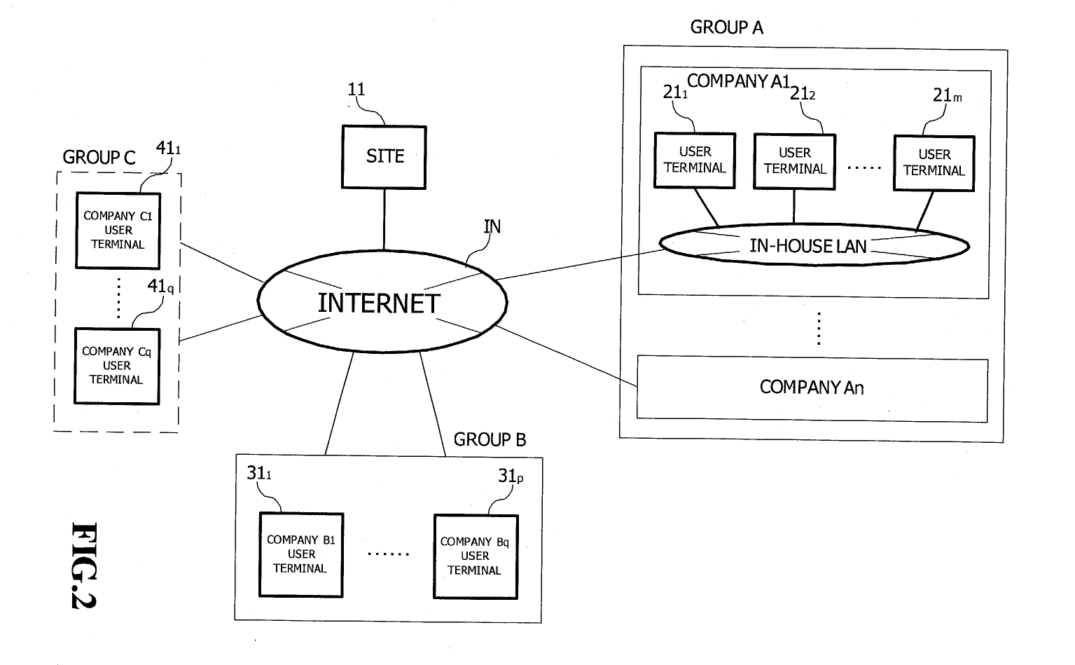

An example of the above embodiment will now be described with reference to FIGS. 2 to 18.

FIG. 2 is a diagram showing the structure of a business trade assisting system according to an example of the present invention. As shown in FIG. 2, the system comprises the site 11 on the internet IN, and groups of terminals 21 (211-21m), 31 (311-31p), and 41 (411-41q) those being connected to the internet IN directly or via LAN, an internet gateway, an access point or the like.

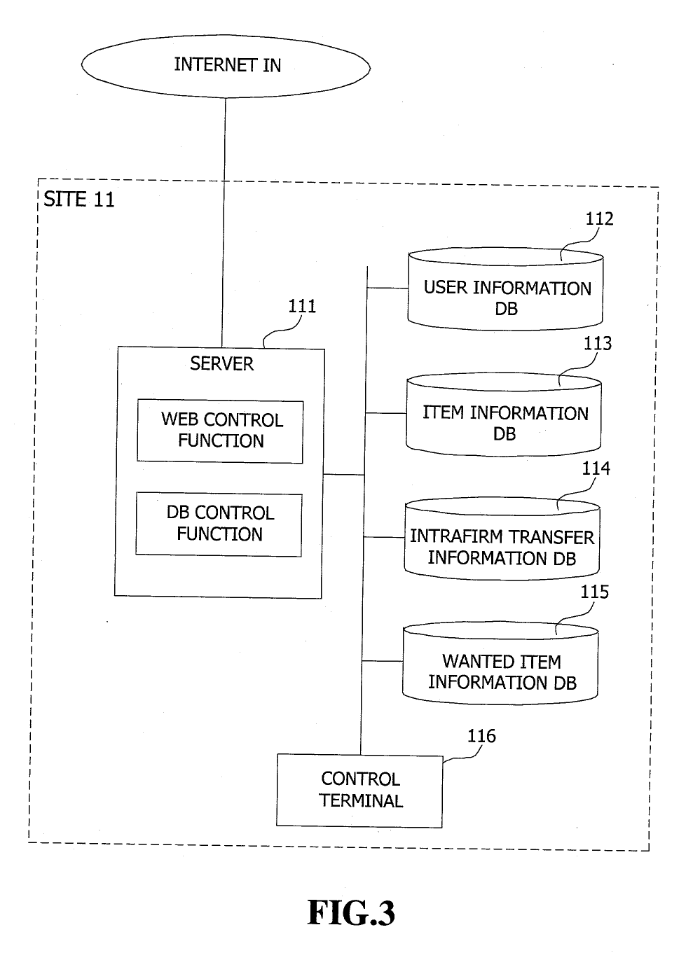

The site 11 provides the cyber market. As shown in FIG. 3, the site 11 comprises a server 111, a user information DB (database) 112, an item information DB 113, an intrafirm transfer information DB 114, a wanted item information DB 115, and a control terminal 116.

The server 111 has a function as a WWW server (web control function) and another function as a DB server (DB control function). Physical configuration of the server 111 is not limited, that is, a single computer machine may work as the server 111, or a plurality of computer machines may collaborate each other to work as the server 111.

At a phase of the WWW server, the server 111 accepts accesses from the user terminals via the internet IN with authentication process. And, the server 111 retrieves information from the databases 112 to 115 to dynamically generate home pages, and provides the accessing user terminal of thus generated home page.

At a phase of the DB server, the server 111 accesses the user information DB 112, the item information DB 113, the intrafirm transfer information DB 114, and the wanted item information DB 115.

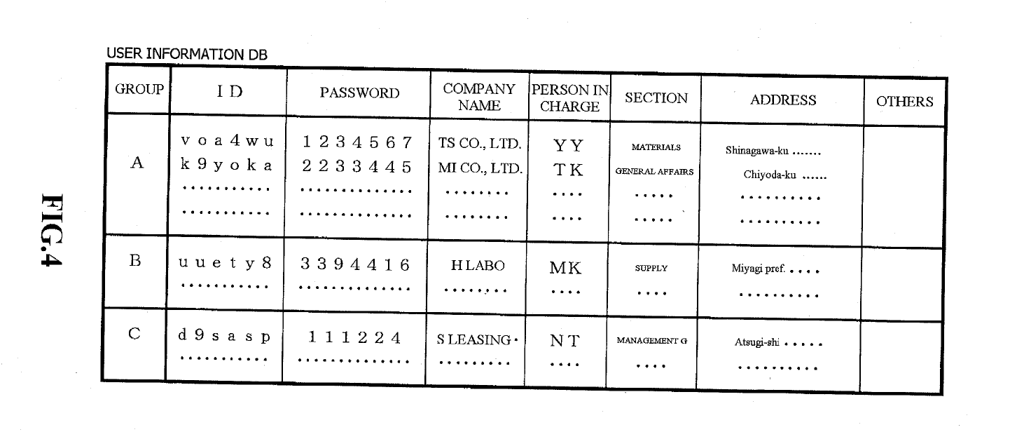

As shown in FIG. 4, the user information DB 112 stores information regarding to the users allowed to access the site 11. Articles included in the information are: Group, ID, Password, Company Name, Person in Charge, Section in Charge, Contact Information (address, phone number, facsimile number, e-mail address), and the like.

“Group” indicates each one of the groups A to C to which different priorities are assigned respectively. “ID” represents a discriminative tag assigned to each business body. “Password” is authentication data required at logging in the site 11. The site 11 discriminates a visitor based on ID, and authenticate the visitor based on a pair of ID and password. “Company Name” include information representing user name. Ordinary, those may be names of company, laboratories, universities, and the like. “Person in Charge” and “Section in Charge” represent names of a person and a section dealing with the site 11. “Contact Information” represents information for contact the person in charge, such as address, phone number, facsimile number, and e-mail address.

Of those information sets, information of the group A members and the group B members are usually obtained by canvassers of the site holder. On the contrary, the group C users has signed-up by the user itself through a predetermined sign-up form on the site 11.

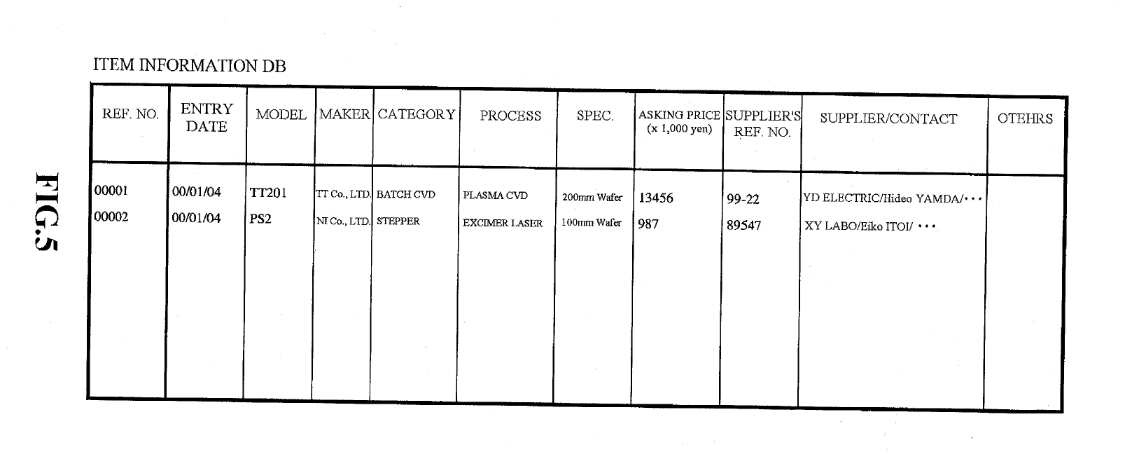

The item information DB 113 stores information regarding to used semiconductor manufacturing apparatuses being subject to the business trades held (in the cyber market) through the site 11. As shown in FIG. 5, articles of the information in the item information DB 113 are: Reference Number, Entry Date, Model, Maker, Category, Process, Specification, Asking Price, Supplier's Number, Supplier/Contact Info., and the like. “Entry Date” means the date when the used semiconductor manufacturing apparatus is entered for the site 11 as a for-sale item. Information in “Model”, “Maker”, “Category”, “Process”, and “Specification” works as an index for easy search of the semiconductor manufacturing apparatuses being subject to the business trades. “Asking Price” represents sales price desired by the supplier. “Supplier's Number” represents reference number of the apparatus concerned given by the supplier. “Supplier/Contact Info.” includes information of a person in charge, a section in charge, address and other contact information, and the like of the supplier.

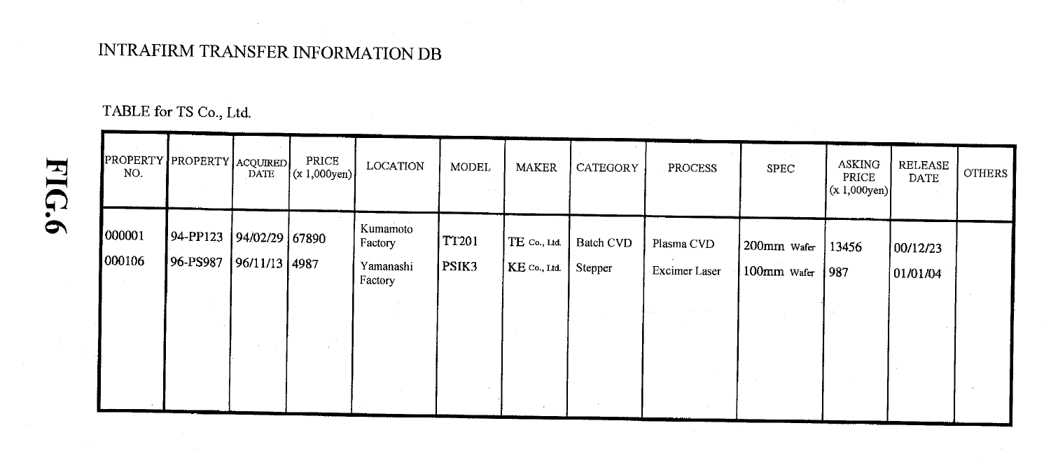

As shown in FIG. 6, the intrafirm transfer information DB 114 stores information categorized into the business bodies, each representing semiconductor manufacturing apparatuses being subject to intrafirm transfer in the business body concerned. Articles of the information in the intrafirm transfer information DB 114 are: Property Number, Property, Acquired Date, Price at Acquisition, Location of Apparatus, Model, Maker, Category, Process, Specification, Asking Price, Scheduled Release Date, and the like. “Property Number” and “Property” represent the properties concerned. Information in “Model”, “Maker”, “Category”, “Process”, “Specification” works as an index for easy search.

The wanted item information DB 115 stores entries of used semiconductor manufacturing apparatuses being wanted by the users belonging to any one of the groups A to C. The entry may include articles of Model, Category, Process, Specification, Product Year, Budget, and the like.

The user terminals 21, 31, and 41 shown in FIG. 2 may be personal computers or workstations each comprising a telecommunication unit, a display unit, an input unit, a control unit and the like, and web browser program has been installed therein.

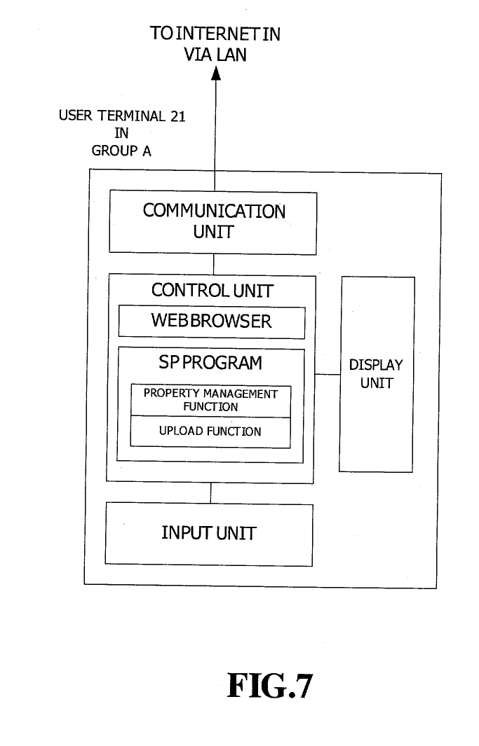

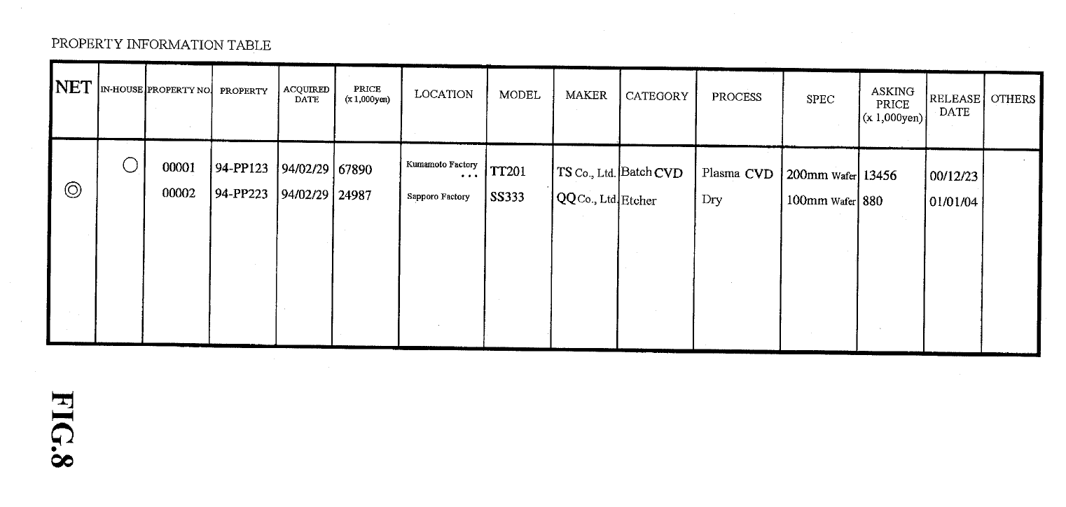

In addition to the web browser, special programs designed for interact with the site 11 are installed in the user terminals 21 of the business bodies belonging to Group A, as shown in FIG. 7. The special program has a function for managing the semiconductor manufacturing apparatuses owned by the business body concerned, and telecommunication function. More precisely, the special software has a template as shown in FIG. 8. A person in charge in the business body concerned may enter property owned by the business body for the template for managing it.

As shown, the template includes a pointer indicating whether “for-sale” entry had been entered for the site 11 before, and another pointer indicating whether “intrafirm transfer” had been entered for the site 11 before. The template also includes articles of Property, Date of Acquisition, Price at Acquisition, Location of the Apparatus, Model, Maker, Category, Process, Specification, Price, Scheduled Release Date, and the like.

The special program also has upload function which retrieves data corresponding to the pointer being set at “NET”, and uploads it to the site 11 as for-sale item, while retrieves data corresponding to the pointer being set at “In-house” to uploaed to the site 11 as an intrafirm transfer item.

Operations of the system having the above structure will now be described.

(User Sign Up)

To participate in business trades in the cyber market on the site 11, user sign-up is required. A canvasser of the site 11 visits business bodies which may be categorized into group A or group B, such as semiconductor maker, to invite them to the site 11 with explaining the aim or details of the site 11. The site 11 issues an ID to a business body which decided to participate in the site 11. Those business bodies determine their own password. The system administrator of the site 11 registers ID, password, company name, and the like (user information) to the user information DB 112.

In case of general business bodies other than the above, they may access the server 111 via a certain internet service provider (ISP: not shown) with using arbitrary WWW browser installed in a terminal (hereinafter, referred to as user terminal 41).

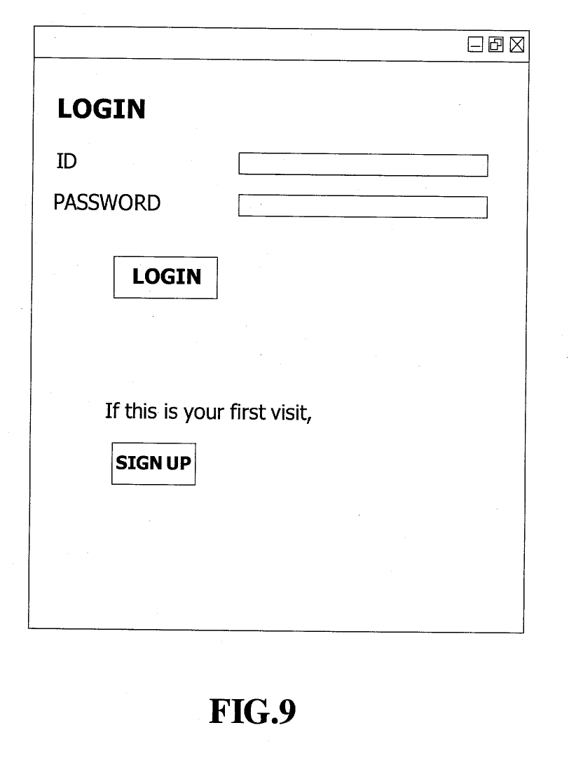

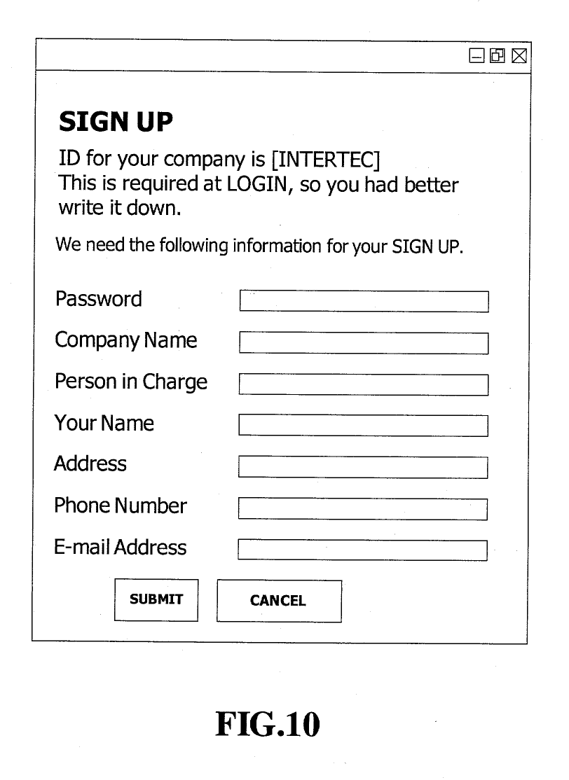

In response to the access, the server 111 transmits a top page shown in FIG. 9 to the user terminal 41. Since the business body concerned is unregistered user, the operator may clicks “Sign In” button on the top page shown in FIG. 9 in accordance with the displayed guidance. This operation causes the server 111 to issue user ID (for example, serial number or random number), and transmits a sign-up page as shown in FIG. 10 to the user terminal 41. The user terminal 41 displays the page.

The user inputs necessary information such as company name and name of person in charge through the displayed page, then clicks “Submit” button. This operation causes the user terminal 41 to transmit ID and input information (user information) to the server 111. The server 111 receives the user information, and enters it for the group C area in the user information DB 112 as shown in FIG. 4.

(Operations for Property Management)

As described above, the terminal 21 which is operated by the person in charge in the business body of Group A, has been equipped with the special program for using the site 11. The operator executes the special program for managing their properties. To begin with, the person in charge enters information of their own semiconductor manufacturing apparatuses for the template shown in FIG. 8. Additionally, information of disposed or sold properties is deleted. Thus, the template presents helpful information representing the status of their properties to the person in charge who wants to check the status.

(Operations for Intrafirm Transfer)

In a case, for example, where replacement of the equipment in the group A business body produces surplus apparatuses, a section in charge notifies a property manager of it. The property manager may investigate the semiconductor manufacturing apparatuses to determine whether those are applicable to the intrafirm transfer. If it is appropriate for intrafirm transfer, the property manager arranges procedures for it. Using the site 11 may be one of the solutions to achieve the intrafirm transfer efficiently. In this case, the operator may executes the special program in the user terminal 21 to retrieve the property table shown in FIG. 8. The operator inputs a symbol (for example, “ ”) representing “upload” to the column “in-house” corresponding to the apparatus concerned to specify it, then clicks “Upload” button (not shown).

This operation causes the upload function of the special program to access the server 111 via the ISP or the like, and automatically transmit ID, password, and the like. Thus, the server 111 is notified that the information of intrafirm transfer being uploaded. The upload function also recognizes updates of the symbol“ ” in the “In-house” of the property information table, and transmits the information of the apparatus corresponding to the update to the server 111.

The server 111 determines whether “Group A” in the user information DB 112 has had the entry of the notified pair of ID and password. If the entry is not found, the server 111 replies an error message saying it. On the contrary, if the entry is found, the server 111 specifies the business body concerned based on its ID, and adds the received information to the table prepared for the business body concerned in the intrafirm transfer DB 114.

If demand for facility acquisition which should be done by intrafirm transfer occurs, a facility manager of the business body in Group A may operates the browser or the like in a user terminal (hereinafter, referred to as user terminal 21) to access the site 11 via the ISP or the like.

In response to the access, the site 11 presents the top page shown in FIG. 9. The facility manager inputs ID and password onto the top page, and clicks “Login” button.

The server 111 determines whether “Group A” in the user information DB 112 has had the entry of the notified pair of ID and password. If the entry is not found, the server 111 replies an error message saying it.

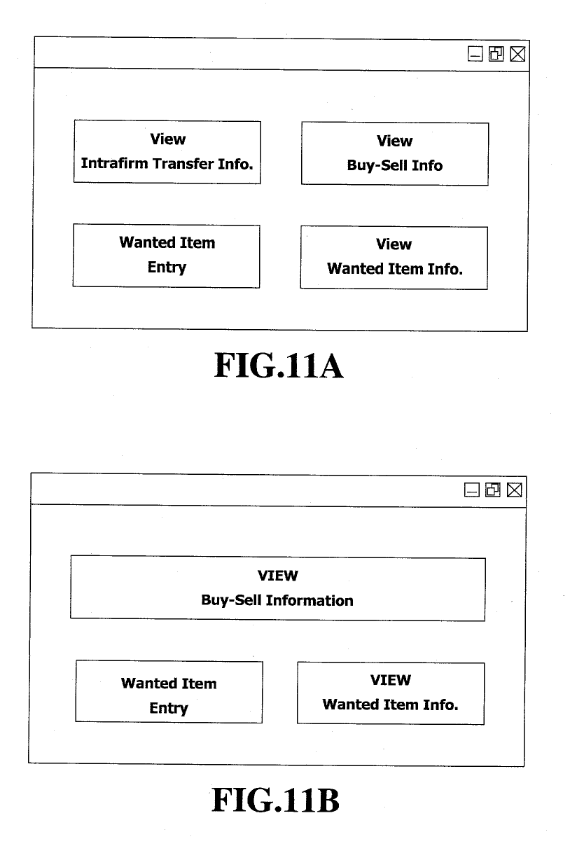

On the contrary, if the entry is found, the server 111 transmits a menu page shown in FIG. 11(a) to the user terminal 21. The user terminal 21 receives the menu page, and displays it through the browser or the like. The user designates “View intrafirm transfer” to notify the server 11 of it.

In response to the selection of “View intrafirm transfer”, the server 11 retrieves the transfer information table as shown in FIG. 6 prepared for the business body concerned represented by the ID and password. The server 11 generates presentation information written by HTML (web page) with CGI support, and transmits it to the user terminal 21. The user terminal 21 displays the received page (intrafirm transfer information) through the web browser. The page presents a list of their apparatuses for intrafirm transfer to the facility manager.

If a wanted apparatus is found, the facility manager may contacts the section in charge or the like to proceed following procedures.

If the intrafirm transfer concerned is concluded after the procedures, the property manager executes the special software to inform the server 111 that the apparatus concerned has been removed from the nomination for intrafirm transfer. In response to the notice, the server 111 deletes information regarding to the apparatus from the table in the intrafirm transfer DB 114 which has been prepared for the business body concerned.

Accordingly, the business body in Group A is allowed to use the site 11 as its private site to exchange information of the intrafirm transfer of apparatuses. It is helpful for a section having an apparatus to be transferred and another section which wants to acquire the apparatus, to exchange information therebetween easily and promptly, thus the efficiency of the intrafirm transfer will be improved.

(Operations for Selling Used Semiconductor Manufacturing Apparatuses)

In a case, for example, where a certain business body has surplus apparatus caused by replacement of the equipment, a section in charge may notifies a property manager of it. If the property manager determines that the apparatus concerned is not subject to the intrafirm transfer based on the investigation, the property manager considers whether it should be sold to the outside. The property manager also considers such the matter in a case where an appropriate acceptor of an item for the intrafirm transfer exemplified above has not been found in a predetermined term.

To use the site 11 for selling an item to the outside, execute the special program in the user terminal 21 to open the property information table shown in FIG. 8. Then, set a symbol representing “upload”, for example, “ ” to the column “NET” corresponding to the apparatus being subject to the intrafirm transfer to specify the apparatus for the intrafirm transfer, then click “Upload” button (not shown). This action causes the upload function of the special program, thus it establishes the connection to the server 11 via the ISP or the like and automatically transmits ID, password, and the like to notify the server 111 that the information of for-sale is being uploaded. Additionally, the upload function discriminates the apparatuses corresponding to newly affixed symbols “ ” in “NET” column, and transmit information regarding to the apparatus concernedes to the server 111.

The server 111 determines whether Group A in the user information DB 112 has had the entry of the notified pair of ID and password. If the entry is not found, an error message is sent as a reply. On the other hand, if the entry is found, the information received is added to the information stored in the item information DB 113 as shown in FIG. 5. In this case, “Entry Date” represents the day concerned, “Supplier” represents a business body specified by ID and password, and Person in Charge, Address, and the like represent the person in charge, contact information, and the like being stored in the user information DB 1113.

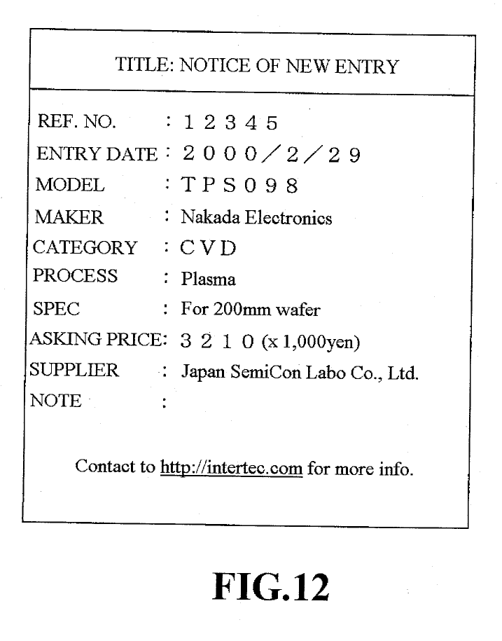

In accordance with the new entry, the server 111 retrieves the information concerned, and generates an e-mail as shown in FIG. 12 with retrieving e-mail addresses of the persons in charge in the business bodies of Group A, and transmit it to them. Each of the persons in charge of the business bodies of Group A is notified that for-sale information has been updated, with details of the update, asking price, and the like by the e-mail prior to the business bodies of Groups B and C.

A facility manager of the business body in any of the groups A to C may operates the user terminal to access the site 11 via the ISP or the like, when intends to acquire a used semiconductor manufacturing apparatus. In response to the access, the site 11 presents the top page shown in FIG. 9. The user terminal displays the top page, and the facility manager inputs ID and password through the top page, and clicks “Login” button.

The server 11 determines whether the user information DB 112 has had the entry of the pair of ID and password. If the entry is not found, an error massage is sent as a reply. If the entry is found, it specifies the business body concerned based on ID and password, and determines the group to which the business body concerned belongs. The server 111 carries out the following process in accordance with the determined group.

<In Case of Group A>

The server 111 transmits the menu page shown in FIG. 11(a). The user terminal (hereinafter user terminal 12 because it belongs to Group A) receives the menu page and displays it through the browser or the like. The user designates “View Buy-Sell Information” and notifies the server 111 of it.

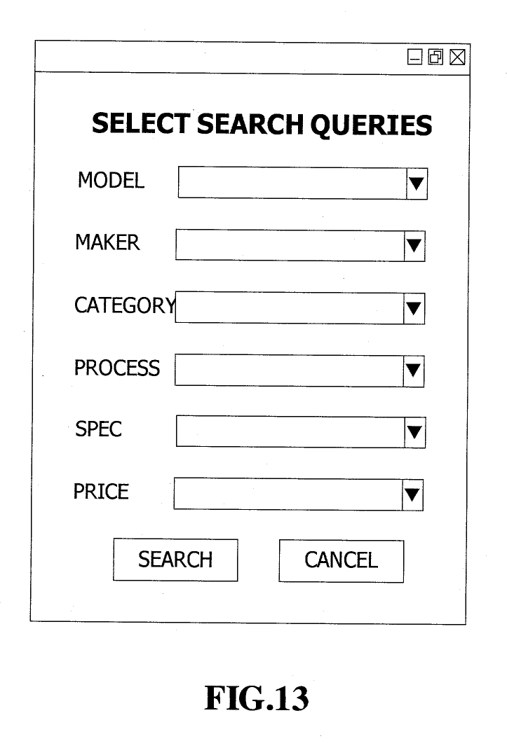

In response to the notice of “View Buy-Sell Information”, the server 111 transmits the search page (search screen) as shown in FIG. 13 to the user terminal 21. The user terminal 21 displays the received search page through the browser. The search page may has combo boxes each shows keywords (search queries) corresponding to model of the apparatus, maker, category, process, specification, price, and the like. The search page allows the user to select keywords by those combo boxes to set search queries. The user is also allowed to input keywords directly.

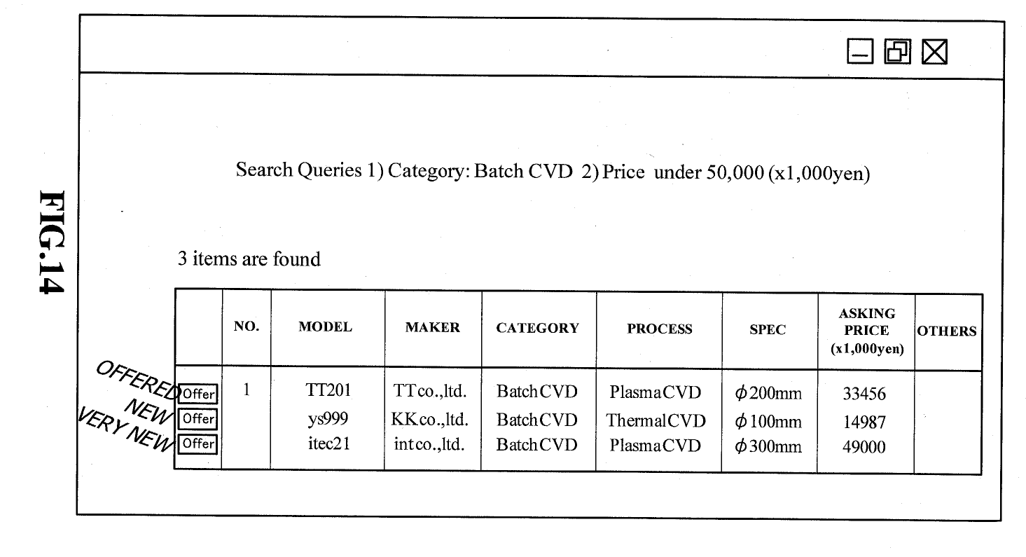

After the search query setting, the user may click “Start Search” button. In response to this action, the user terminal 21 notifies the server 111 of the search queries. The server 111 searches the item information DB 113 for information which matches the search queries notified. The server 111 retrieves the matched information, and generates a page listing the retrieved information as shown in FIG. 14 with CGI support for example. It affixes the indicator such as “Very New” to articles entered within last 2 weeks, and affixes another indicator such as “New” to articles which had been entered within last 1 month except the last 2 weeks. Thus it is indicated which are newly entered articles.

The server 111 transmits the generated page (for-sale list) to the user terminal 21. According to the list displayed on the user terminal 21, the user may discriminates whether it includes wanted item or not.

<In Case of Group B>

Since any services regarding to “intrafirm transfer” are not provided to the users of Group B, it is unnecessary to present the page for selecting “intrafirm transfer” to the users of Group B. Therefore, in a case where the server 111 determines a user belongs to Group B, it transmits another menu page shown in FIG. 11(b). A user terminal (hereinafter, user terminal 31 because it belongs to Group B) receives the menu page and displays it through the browser or the like. The user designates “View Buy-Sell Information”, and transmits it to the server 111. Then the server 111 transmits the search page as shown in FIG. 13 to the user terminal 31. The user terminal 31 displays the received search page through the browser.

After setting search queries, the user may click “Start Search” button. In response to this click action, the user terminal 31 notifies the server 111 of the search queries.

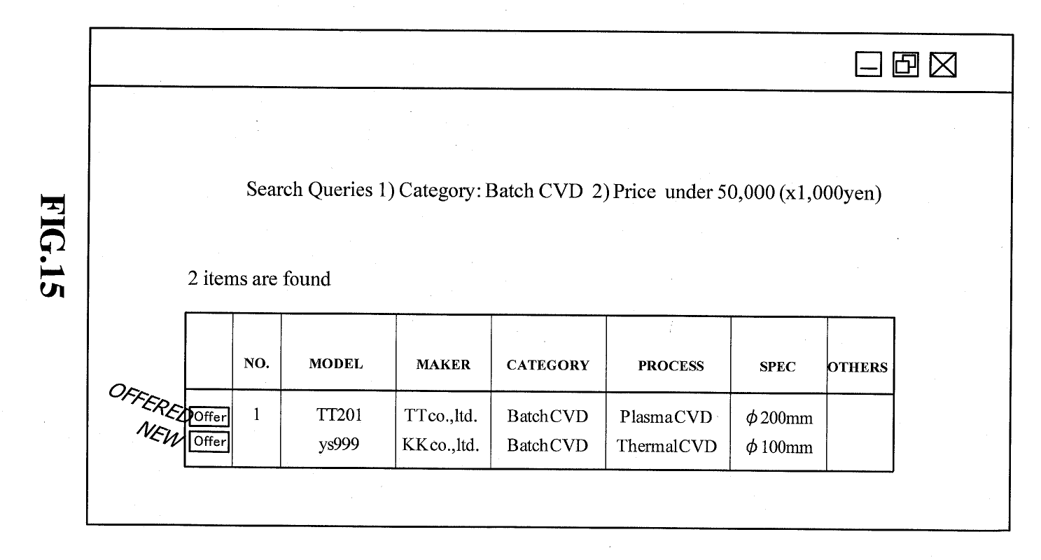

Since the users of Group B are on a restriction “those are allowed to view only information entered before last 2 weeks”, the server 111 adds an extra search query “entered before last 2 weeks” to the notified search queries, and searches for-sale apparatuses for ones match those search queries. The server 111 generates a page listing the information of retrieved items as shown in FIG. 15 with CGI support for example. The indicator such as “New” is affixed to items entered within last 1 month, thus, it indicates which ones are newly entered items, however, “asking price” by the supplier are not displayed on the page.

The server 111 transmits the generated page (for-sale list) to the user terminal 31. Thus the user may discriminate whether wanted item is included or not based on the list being displayed on the user terminal 31.

<In Case of Group C>

Operations in a case where a user belongs to Group C are fundamentally the same as those for the Group B users, however, the server 111 adds an extra search query “entered before last 1 month” to search queries notified by a user terminal (hereinafter, user terminal 41 because it belongs to Group C) in order to fulfil a restriction on Group C users: “those are allowed to view only information entered before last 1 month”. It searches for-sale items for apparatuses match the search queries, and retrieves them. Indications of asking prices given by the suppliers are omitted.

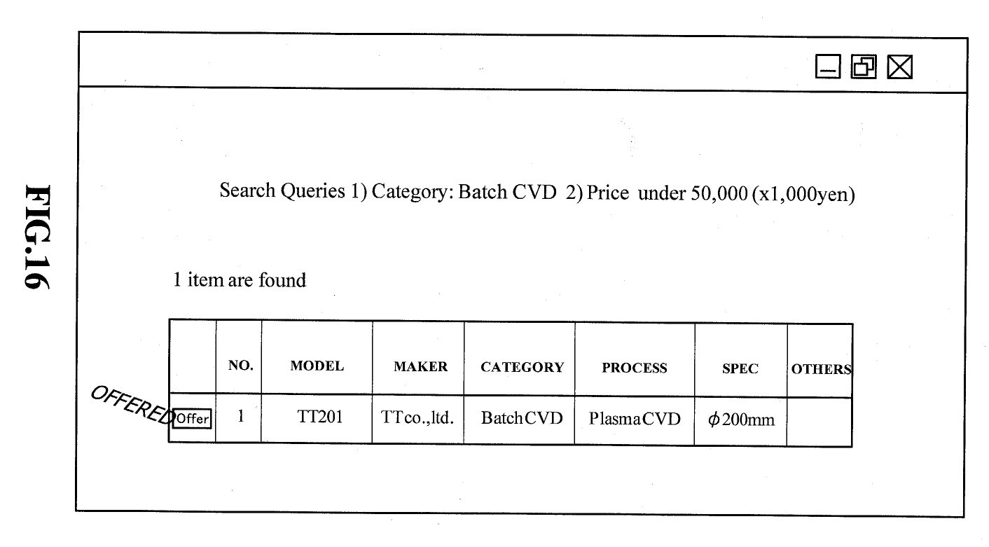

As described above, search results differs in accordance with the group even if the same search queries are given. For example, as shown in FIGS. 14 to 16, in a case where a search under the same search queries results 3 cases wherein: one was entered within last 2 weeks; another was entered within last 1 month except last 2 weeks; and the other was entered before last 1 month, all cases are presented to Group A as shown in FIG. 14 while the group B users are allowed to view information of the cases entered before last 2 weeks without asking price as shown in FIG. 15, and the group C users are allowed to view information of the case entered before last 1 month without asking price as shown in FIG. 16.

If a user (in any one of groups A to C), who views the search result given by the server 111, finds a wanted item (including simpler interests such as “Send me catalogue”, “May I visit to see it?” or “Just interested in”), the user may click “Offer” button at leftward the article concerned. In response to this click action, the user terminal notifies the server 111 that discussion for a business trade has been offered with information representing the business body and item concerned.

The server 111 notifies the control terminal 116 of the received notice, and the control terminal 116 displays it on the screen. Optionally, designation of a person in charge may be carried out previously company by company or item by item, to determine a receiver of e-mails which saying that the discussion (or investigation) for a business trade has been offered. The e-mail may also include relative information representing item concerned and the like.

After the above operation, the administrator of the site 11 intermidiates the business trade between the supplier and buyer, and proceeds it. The server 111, for example, may affix a pointer to items whose “Offer” button was clicked during the stage for presenting the search result shown in any one of FIGS. 14 to 16, to indicate which one has being offered.

<To Enter and View Wanted Item Information>

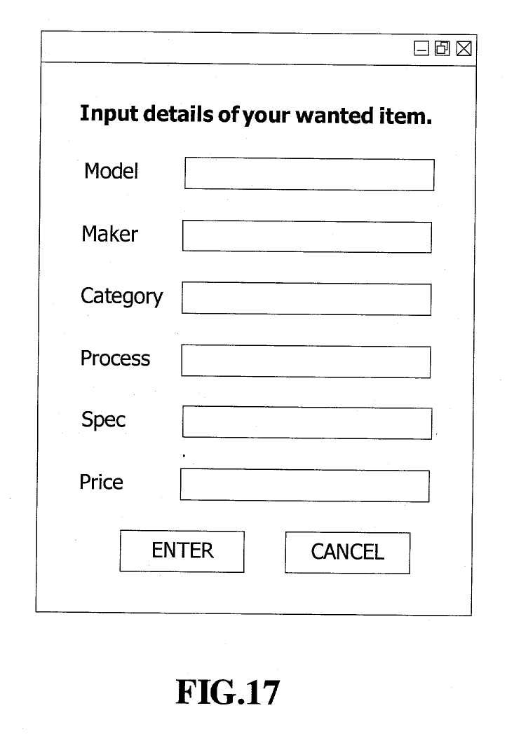

Each of the users is allowed to enter wanted items if the for-sale list does not include items they want. In this case, the user may, for example, click “Enter Wanted Item” button on the page shown in FIGS. 11(a) and (b). In response to this action, the server 111 displays an entry page as shown in FIG. 17 on the user terminal. The user inputs necessary information through the entry page, and clicks “Enter” button. In response to this action, the server 111 enters the input information for the wanted item information DB 115.

The user may click “View Wanted Item Information” on the page shown in FIGS. 11(a) and (b). In response to this action, the server 111 generates a page listing information entered for the wanted item information DB 115, and transmits it to the user terminal.

The user compares the contents of the list with their own to-be-released items. If an appropriate one is found, the user may contact the administrator of the site 11 to proceed following procedures for their business trade.

<Item Entry by Users of Group B or C>

In a case where the user of Group B or C intends to enter for-sale item, the user notifies the system administrator of the site 11 of their for-sale item. The administrator may, for example, operates the control terminal 116 to enter the information regarding to the for-sale item for the item information DB 113. Or, the user may arrange an entry page which allows the user itself to enter the information regarding to their for-sale item.

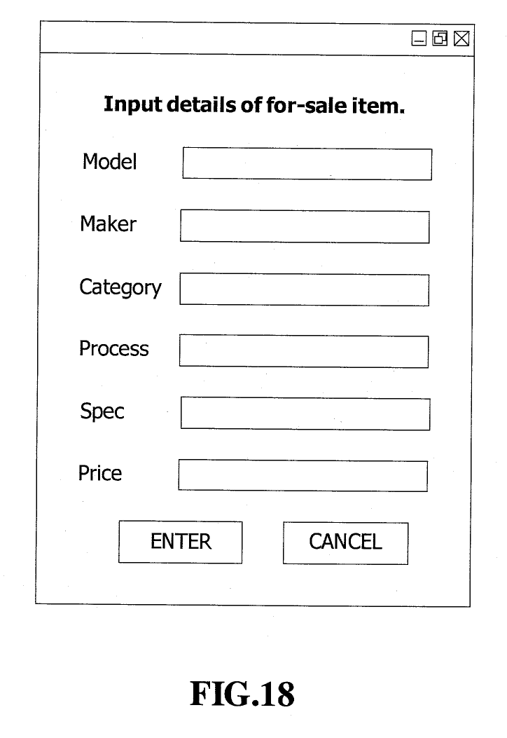

For example, a page for entering information regarding to the for-sale item may be presented to the user who selects “Item Entry” through the page shown in FIG. 18 which follows to the login based on necessary matters input through the login page, thus, the user may be allowed to input information through the presented page.

The system for assisting the used goods sales described above is helpful for improving efficiency in buying-and-selling used goods with using homepages on the internet. And the users are categorized into groups those are prioritized for the access control. Such the priority is incentive to participate in the cyber market for potential suppliers, thus, the market is well supplied and active.

Various embodiments and changes may be made thereunto without departing from the broad spirit and scope of the invention. For example, the number of the groups is not limited to 3. It may be 2 including A and C, or 4 or more groups may be prepared.

Methods for item entry and intermidiation are not limited to those described in the above embodiment. Depending on the kind of item to be handled, the system may have accounting function. Items applicable to the business trade is not limited to the semiconductor manufacturing apparatus. It is also applicable for second hand goods market handling semiconductor related items such as semiconductor investigator, automobiles, houses, and the like.

The system according to the present invention is achievable by not only a specialized system, but also an ordinary computer system. For example, if program sets for above described actions are installed in a computer, it may act as the servers and the like for executing the above described processing tasks. Those program sets to be installed in the computer may be supplied by an arbitrary recording medium (floppy disk, CD-ROM, or the like). In a case where some of the above described functions are achieved by OS, or by collaboration of OS and application programs, the recording medium may store the program sets other than the OS.

Those programs may be distributed via a communications network by superimposing them onto carrier wave signals. For example, those programs may be uploaded to the bulletin board system (BBS) for distributing them via the communications network. Thus distributed programs may be executed under control of OS as well as other application programs, to achieve the above described processing tasks.

This application is based on Japanese Patent Application 2000-344366, and including specification, claims, drawings and summary. The disclosure of the above Japanese Patent Application is incorporated herein by reference in its entirety.

What is claimed is:

1. A method for assisting a business trade between a user who wants to sell an item and the other who wants to purchase an item by accepting an offer for the purchase through a home page disclosing information regarding to items, comprising:
categorizing the users into a plurality of groups to which different priorities are given; and
presenting the information regarding to the items to the users with gradually expanding a scope of the allowance in accordance with the priorities of the groups in order of the priorities from the highest to the lowest.

2. The method for assisting a business trade according to claim 1 comprising:
accepting said item entry;
obtaining time passage since the entry; and
specifying a group to which information regarding to the item is presented, based on the obtained time passage.

3. The method for assisting a business trade according to claim 1 comprising:
entering information regarding to properties of a business body for a computer to manage them; and
accepting designation of a for-sale item which is one of the properties being managed, and uploading information regarding to the designated for-sale item to a home page,
thus simplifying process of the property management and sales to the outside.

4. The method for assisting a business trade according to claim 1 comprising:
allowing a business body to enter items being subject to intrafirm transfer, and presenting information regarding to items being subject to the intrafirm transfer only to the users belonging to the business body concerned.

5. The method for assisting a business trade according to claim 4 comprising:
entering information regarding to properties of the business body for a computer to manage it; and
accepting designation of an item to be subject to intrafirm transfer which is one of the properties being managed, and uploading information regarding to the designated item being subject to the intrafirm transfer to a home page, thus allowing the business body to share the information regarding to the item being subject to the intrafirm transfer.

6. A system for assisting a business trade between a user who wants to sell an item and the other who wants to purchase an item by accepting an offer for the purchase from the applicant for the purchase through a home page disclosing information regarding to for-sale items, comprising:
a user information storing means for categorizing users into n (a natural number equal to or greater than 2) groups to each of which priority for information disclosure is assigned, and for storing information regarding to each of the users;
an item information storing means for accepting information regarding to for-sale items, and for storing the accepted information; and
an information presentation means for specifying the group to which a user belongs, based on the information stored in said user information storing means, in response to access by the user via the network, retrieving information viewable by the specified group from the information regarding to the for-sale items stored in said item information storing means, and presents the retrieved information to the user via the network.

7. The system for assisting a business trade according to claim 6, wherein
said item information storing means stores entry date of said for-sale items, and
said information presentation means obtains passage of time since the entry date for each for-sale item, and presents information to the users belonging to the group in accordance with the obtained period.

8. The system for assisting a business trade according to claim 7, wherein
said information presentation means presents the information regarding to the for-sale items only to the users who belongs to the highest prioritized group during a predetermined period since the entry date until conclusion of the business trade, and gradually presents the information also to other users who belongs to the groups whose priority is the second best or lower after said predetermined period is lapsed in accordance with the time passage.

9. The system for assisting a business trade according to claim 6, wherein:
a telecommunications interconnects a means for entering and managing information regarding to properties owned by the users, and a computer which accepts designation of a for-sale item which is one of the properties being managed; and notifies said business trade assisting system of the information regarding to the designated property for entry as for-sale item information.

10. The system for assisting a business trade according to claim 6, wherein
said for-sale items are used goods,
said item information storing means comprises transfer information storing means for entering information regarding to intrafirm transfer before the entry of said for-sale items,
said information presentation means comprises a means for presenting the information regarding to the items to be transferred, only to the signed-up business body and the users belonging to the business body concerned, and said item information storing means comprises a means for switching the information regarding to the items to be transferred into information of items to be sold to other business body.

11. The system for assisting a business trade according to claim 10, wherein:
a telecommunications interconnects a means for entering and managing information regarding to the properties owned by the user, and a computer comprising a means for accepting designation of an item to be transferred which is one of the properties being managed, and notifying said business trade assisting system of the information regarding to the designated property as an item to be transferred.

12. The system for assisting a business trade according to claim 6, wherein
said group having the highest priority includes the users who supply the for-sale items, and
said item information storing means comprises a means for accepting the entry of the for-sale items from the users in said highest priority group.

13. A computer readable recording medium storing a program which causes a computer to act as a server which assists a business trade between one who wants to sell an item and the other who wants to purchase an item by accepting an offer from an applicant for the purchase through a home page disclosing information regarding to for-sale items, comprising:
a user information storing means for categorizing users into n (a natural number equal to or greater than 2) groups to which different priorities for information disclosure are assigned, and for storing information regarding to each of the users;
an item information storing means for accepting information regarding to for-sale items, and for storing the accepted information; and
an information presentation means for specifying the group to which a user belongs, based on the information stored in said user information storing means, in response to access by the user via the network, retrieving information viewable by the specified group from the information regarding to the for-sale items stored in said item information storing means, and presents the retrieved information to the user via the network.

14. A computer readable recording medium storing a program which causes a computer:
to connect to a server which assists a business trade between one who wants to sell an item and the other who wants to purchase an item by accepting an offer from an applicant for the purchase through a home page disclosing information regarding to for-sale used items, and
to comprising a management means for entering and managing information regarding to the properties owned by the users, and a means for accepting designation of a for-sale item which is one of the properties from a user, and notifying said server of the information regarding to the designated property to enter as a for-sale used item.
